(19) United States
(12) Patent Application Publication
(10) Pub. No.: US 2009/0250661 A1
(43) Pub. Date: Oct. 8, 2009

(54) Trimetallic Nitride Clusters Entrapped Within CnN Heteroatom Cages

(76) Inventors: Steven A. Stevenson, Hattiesburg, MS (US); Harry C. Dorn, Blacksburg, VA (US); Tianming Zuo, Harrisonburg, VA (US)

Correspondence Address: HOWREY LLP-HN, C/O IP DOCKETING DEPARTMENT, 2941 FAIRVIEW PARK DRIVE, SUITE 200, FALLS CHURCH, VA, 22042-7195, US

(21) Appl. No.: 12/354,086

(22) Filed: Jan. 15, 2009

Related U.S. Application Data
(60) Provisional application No. 61/021,913, filed on Jan. 18, 2008.

(51) Int. Cl. C09K 3/00

(52) U.S. Cl. 252/182.33; 977/736

(57) ABSTRACT

The present invention is directed to a family of trimetallic nitride endohedral metalloheterofullerenes having the formula Aₓ X₃₋ₓ N@Cₙ N, (x=0, 1, 2 or 3) (n=number of carbon atoms in the cage, typically between 59 and 199), wherein A and X are metal atoms encased within the cage, C is carbon and N is nitrogen. A and X are preferably selected from rare earth elements or group IIIB elements. A or X metal atoms are scandium, yttrium, lanthanum, gadolinium, lutetium, holmium, erbium, thulium, dysprosium, neodymium, cerium, praseodymium and ytterbium. Representative embodiments include Sc₃N@C₇₉N, Y₃N@C₇₉N, La₃N@C₇₉N, Tb₃N@C₇₉N, Ho₃N@C₇₉N, LaSc₂N@C₇₉N, PrSc₂N@C₇₉N, GdSc₂N@C₇₉N, La₂ScN@C₇₉N, and Gd₂ScN@C₇₉N. The present invention is also directed to a method of making the inventive endohedral metalloheterofullerenes having the formula AₓX₃₋ₓN@CₙN. These methods involve use of oxidizing gases (e.g. O₂ and NOₓ) coupled with combustion as a means for making trimetallic nitride clusters encapsulated in heteroatom CₙN cages made of both carbon and nitrogen.

This application claims the benefit of U.S. Provisional Application No. 61/021,913 filed Jan. 18, 2008, the contents of which are incorporated herein by reference in their entirety.

This invention was made with government support under NSF grant #0547988, NSF NIRT grant #477370 and NIH grant #415509. The government has certain rights in this invention.

### FIELD OF THE INVENTION

The present invention relates to trimetallic nitride clusters encased within heterofullerene CₙN cages and to the methods of making them with oxidizing gases (e.g., O₂ and NOₓ) and combustion.

### BACKGROUND OF THE INVENTION

Fullerenes are a family of closed-caged molecules made up of carbon atoms. The closed-caged molecules consist of a series of five and six member carbon rings. The fullerene molecules can contain 60 or more carbon atoms. The most common fullerene is the spherical C₆₀ molecule taking on the familiar shape of a soccer ball.

Fullerenes are typically produced by an are discharge method using a carbon rod as one or both of the electrodes in a Krätschmer-Huffman generator. Krätschmer, W. et al., Chem. Phys. Lett., 170, 167-170 (1990). Typically the generator has a reaction chamber and two electrodes. The reaction chamber is evacuated and an inert gas is introduced in the reaction chamber at a controlled pressure. A potential is applied between the electrodes in the chamber to produce an are discharge. The are discharge forms a carbon plasma in which fullerenes of various sizes are produced.

Many derivatives of fullerenes have been prepared including encapsulating metals inside the fullerene cage. Metal encapsulated fullerenes are typically prepared by packing a cored graphite rod with the metal oxide of the metal to be encapsulated in the fullerene cage. The packed graphite rod is placed in, the generator and are discharged to produce fullerene products. The formation of metal encapsulated fullerenes is a complicated process and typically yields only very small amounts of the metal fullerenes.

U.S. Pat. No. 6,303,760, herein incorporated by reference in its entirety, describes a family of endohedral metallofullerenes where a trimetallic nitride is encapsulated in an all-carbon fullerene cage. The endohedral metallofullerenes have the general formula A₃₋ₙXₙN@Cₘ (n=0-3) where A is a metal, X is a second trivalent metal, n is an integer from 0 to 3, and m is an even integer from about 60 to about 200. The metals A and X may be an element selected from the group consisting of a rare (earth element and a group IIIB element and may be the same or different. In some embodiments, A and X may be selected from the group consisting of scandium, yttrium, lanthanum, gadolinium, holmium, erbium, thulium, and ytterbium, where A and X may be the same or different. These novel trimetallic nitride endohedral metallofullerenes are produced by introducing nitrogen gas into the Kratschmer-Huffman generator during vaporization of packed graphite rods containing corresponding metal oxides, known as the trimetallic nitride template (TNT) process.

The present invention seeks to provide trimetallic nitride endohedral metalloheterofullerenes. Heterofullerene cages (e.g., C₅₉N, C₆₉N, C₇₉N have one carbon on the fullerene cage surface substituted with a different type of atom (e.g., N). Having just one atom of difference has the following effects: (1) changing the reactivity of the entire molecule relative to all carbon cages C₆₀, C₇₀, C₈₀ (2) the ability of the heteroatom to serve as a unique linking site to subsequent chemistry (i.e., functionalization). These phenomena serve as the motivation to pursue heterofullerene cages. With metallic nitride clusters entrapped within the heteroatom cage, we can now also take advantage of the metals' utility in application areas such as Gd₃N@C₇₉N for MRI contrast agents, Ho₃N@C₇₉N for radiopharmaceuticals, Er₃N@C₇₉N for optical and photovoltaic applications, and Lu₃N@C₇₉N for X-Ray contrast agents.

### BRIEF SUMMARY OF THE INVENTION

The present invention is directed to a family of endohedral trimetallic nitride metalloheterofullerenes having the formula A₃N@CₙN or AₓX₃₋ₓN@CₙN, (x=0, 1, 2 or 3) (n=number of carbon atoms in the cage, typically between 59 and 199), wherein A and X are metal atoms encased in the cage, C is carbon and N is nitrogen. A and X are preferably selected from rare earth elements or group IIIB elements. A or X metal atoms can be scandium, yttrium, lanthanum, neodymium, cerium, terbium, thulium, gadolinium, holmium, erbium, thulium, dysprosium, praseodymium and ytterbium. Representative embodiments include Sc₃N@C₇₉N, Y₃N@C₇₉N, La₃N@C₇₉N, Gd₃N@C₇₉N, Tb₃N(C₇₉N, Ho₃N@C₇₉N, and mixed-metal trimetallic nitride metalloheterofullerenes such as LaSc₂N@C₇₉N, PrSc₂N@C₇₋₉N, GdSc₂N@C₇₉N, and Gd₂ScN@C₇₉N. Additionally, the present invention provides an endohedral metalloheterofullerene having the formula: AXZN@CₙN, (n=an odd integer between about 59 and about 199), wherein A, X, and Z are any combination of all dissimilar transition metal or rare-earth metal atoms, such as GdScHoN@CₙN or GdHoErN@CₙN.

The present invention is also directed to a method of making the inventive endohedral metalloheterofullerenes having the formula AₓX₃₋ₓN@CₙN. These methods involve use of oxidizing gases (e.g. O₂ and NOₓ) coupled with combustion as a means for making trimetallic nitride clusters encapsulated in heteroatom CₙN cages made of both carbon and nitrogen. NOx is a generic term for NO and NO₂ and further including N₂O, N₂O₅, N₂O₃, N₂O₄. Briefly, the method includes charging a reactor with a first metal, carbon, O₂ and NOₓ; and reacting by combusting the O₂ and NOₓ, the first metal, and the carbon in the reactor to form an endohedral metalloheterofullerene. The first metal and carbon are introduced in the reactor in the form of a rod filled with a mixture of a first metal oxide (with or without graphite), wherein the first metal oxide is an oxide of the first metal.

The first metal is selected from the group consisting of a rare earth element and a group IIIB element. Typically, the first metal is selected from the group consisting of group IIIB or rare-earth elements, e.g., scandium, yttrium, lanthanum, gadolinium, holmium, erbium, thulium, and ytterbium. The first metal may have an ionic radius below about 0.095 nm. Further, the first metal may be a trivalent metal. The mixture comprises from about 1% to about 5% first metal oxide by weight. Typically the mixture comprises about 3% first metal oxide by weight. The method includes a mixture having from about 1% to about 5% first metal oxide by weight and from about 1% to about 5% second metal oxide by weight. Typically, the mixture has about 3% first metal oxide and about 2% second metal oxide by weight. Alternatively the mixture of the first metal or metal oxide plus the second metal or metal oxide can sum to 99>% with as little as <1% NOx. Addition of graphite powder to the metal mixture is optional.

### BRIEF DESCRIPTION OF THE DRAWINGS

FIG. 1 is an overview of an unexpected, inverse relationship of C₈₀ cages made using traditional methods (N₂ gas, NH₃ gas) versus our new method of making C₇₉N cages with NOₓ, O₂, and air in combustion reactions.

FIG. 2 depicts mass spectral data showing existence of scandium-based homometallic M₃N@CₙN Type I species before (2a) and after HPLC purification (2b).

FIG. 3 depicts mass spectral data showing the existence of mixed-metal trimetallic nitride clusters in heterofullerene cages of type II species, AₓZ₃₋ₓ@CₙN: Gd₂ScN@C₇₉N (Panel 3a); GdSc₂N@C₇₉N (Panel 3b): PrSc₂N@C₇₉N (Panel 3c) and LaSc₂N@C₇₉N (Panel 3d).

FIG. 4 demonstrates successful formation of trimetallic nitride metalloheterofullerenes of different size cages (e.g., La₃N@C₇₉N and La₃N@C₈₇N in (d,f) and mixed metal trimetallic nitride metalloheterofullerenes of C₇₉N cages (b,c). A trace of Sc₃N@C₇₉N is formed with a predominant amount of Sc₃N@C₈₀ (a).

FIG. 5 demonstrates use of N₂ in the formation of trimetallic nitride clusters in a fullerene cage without any detectable formation of trimetallic nitride metalloheterofullerenes, e.g. SC₃N@C₈₀ (5a); LaSc₂N@C₈₀ (5b); La₂ScN@C₈₀ (Sc); and La₃N@C₈₀ (5d).

### DETAILED DESCRIPTION OF THE INVENTION

The present invention is directed to trimetallic nitride endohedral metalloheterofullerenes. In accordance with an embodiment of the present invention, trimetallic nitride endohedral metalloheterofullerenes are synthesized by use of oxidizing gases (e.g. O₂ and NOₓ) coupled with combustion.

As used herein, “endohedral” refers to the encapsulation of atoms inside the fullerene cage network. Accepted symbols for elements and subscripts to denote numbers of elements are used herein. Further, all elements to the right of an @ symbol are part of the fullerene cage network, while all elements listed to the left are contained within the fullerene cage network. Under this notation, Sc₃N@C₇₉N indicates that the Sc₃N trimetallic nitride is situated within a C₇₉N heterofullerene cage.

The present invention is directed to a family of endohedral metalloheterofullerenes having the formula A₃N@CₙN or AₓX₃₋ₓN@CₙN, (x=0, 1, 2 or 3) (n=number of carbon atoms in the cage), wherein A and X are metal atoms encased in the cage, C is carbon and N is nitrogen. A or X metal atoms are transition and/or rare-earth elements such as scandium, yttrium, lanthanum, cerium, lutetium, gadolinium, holmium, erbium, thulium, dysprosium, praseodymium and ytterbium. Representative embodiments include Sc₃N@C₇₉N, Y₃N@C₇₉N, La₃N@C₇₉N, Tb₃N@C₇₉N, Ho₃N@C₇₉N, LaSc₂N@C₇₉N, PrSc₂N@C₇₉N, GdSc₂N@C₇₉N, and Gd₂ScN@C₇₉N. Representative examples cover both generic molecular formulas (i.e., homometallic, Type I (A₃N@CₙN) or mixed-metal nitride clusters, Type II (AₓX₃₋ₓN@CₙN)) described above. Examples of Type I homometallic class of trimetallic nitride metallofullerenes include, but are not limited to, species such as Sc₃N@C₇₉N, Y₃N@C₇₉N, Tb₃N@C₇₉N, Ho₃N@C₇₉N, La₃N@C₇₉N, Gd₃N@C₇₉N etc). Type II compositions of matter include, but are not limited to, mixed-metal, rare-earth containing, trimetallic nitride clusters in CₙN heteroatomic fullerene cages, such as LaSc₂N@C₇₉N, PrSc₂N@C₇₉N, GdSc₂N@C₇₉N, Gd₂ScN@C₇₉N, etc.

In accordance with the present invention, the fullerene cage, Cₙ, can range from about 67 carbon atoms to about 199 carbon atoms. In preferred embodiments, n can be about 67, about 77, 79 or about 87. The hetero N making up the cage is generally limited to a single N atom. In one embodiment, the fullerene cage has a portion of the cage that corresponds to a corranulene-type unit. The corranulene-type unit consists of a five-member ring surrounded by five, six-member rings forming a five-member ring and six-member ring juncture, also called a [5,6] ring juncture. The C₇₉N cages are the highest yielding of the process, but other cage sizes include, but are not limited to C₈₇N, C₉₅N. These larger cages are created in the plasma along with the trimetallic nitride metalloheterofullerene C₇₉N cage.

The encapsulated metals A and X may vary widely. Preferably, when the metallofullerene cage size is between about 68 carbon atoms and about 80 carbon atoms, the metal atoms are trivalent and have an ionic radius below about 0.095 nm. When the size of the fullerene cage is about 68, the metal atoms preferably have an ionic radius below about 0.090 nm for the A₃N endohedral species. As the size of the cage increases, the ionic radius for the metal may increase. Further, A and X may be a rare earth element, a group IIIB element, or combinations thereof. Preferably, A and X may be scandium, yttrium, lanthanum, gadolinium, holmium, erbium, thulium, ytterbium, or heavy other metals, and combination thereof.

The method for making this family of metalloheterofullerenes includes using a Kratschmer-Huffman generator, well known to one skilled in the art. This type of generator typically has a reaction chamber that can be easily evacuated and charged with a controlled pressure of an inert gas such as helium. The generator holds two electrodes within the reaction chamber and is able to apply a potential across the electrodes to produce an arc discharge.

The present method includes mounting a graphite rod, or other source of carbon, that has been filled with a mixture of a metal oxide and graphite in the reaction chamber. The metal or metal oxide contains the metal to be encapsulated in the fullerene cage. The graphite rods are typically cored and filled with a mixture of metal or metal oxide along with graphite, which can be omitted. The metal oxide may be the oxide of a trivalent metal. Preferably the metal oxide is the oxide of a rare earth metal or a group IIIB metal. Metal oxides may include, but are not limited to, Er₂O₃, Ho₂O₃, Y₂O₃. La₂O₃, Gd₂O₃, Tm₂O₃, or Yb₂O₃. For making trimetallic nitride metallofullerenes, typically, the mixture of metal oxide and graphite may be from about 1% to about 5% metal oxide to graphite by weight. Typically, a 3% metal oxide to graphite loading will produce the desired trimetallic nitride endohedral metallofullerene.

When the encapsulation of more than one type of metal in the fullerene cage is desired, the cored graphite rod is filled with a mixture of metal oxides and graphite. The mixture of metal oxides should correspond to the desired metals and graphite. The metal oxides may be combination of trivalent metals in the form of oxides. Preferably, the metals are rare earth metal oxides or group IIIB metal oxides as discussed above. For making trimetallic nitride metallofullerenes, typically, the loading of each metal oxide may be from a 1% to about 5% metal oxide to graphite.

Once the mixture is loaded into the cored graphite rod, the rod is place in the generator and the reaction chamber is evacuated. Helium is introduced into the reaction chamber at about 300 torr along with a small amount of O₂ and NOₓ, about 1 to about 3 torr. A dynamic atmosphere ranging from about 300 ml/min to 1250 ml/min helium and about 20 ml/min to about 300 ml/min O₂ and NOₓ gas may also be utilized. The ratio of helium to O₂ and NOₓ is not critical. The trimetallic nitride endohedral metalloheterofullerenes will be produced for a wide range of helium to nitrogen ratios, but the yield of the trimetallic nitride metallofullerenes may tend to decrease as the amount of nitrogen approaches the amount of helium. The rods can be packed with either metals, metal oxides or other forms of the metals. The rods may or may not include carbon (e.g., graphite) powder. Often times we pack rods with metals (0.01 weight percent to 99.9 weight percent) plus NO, vapor, which can be from any compound containing nitrites or nitrates (e.g., copper nitrate hydrate) added to the packed rods. Alternatively NOx vapor can be made in the reactor by combustion reactions with N2 gas reacting with O2 or air 0.05-20 torr/min to produce NOx in the chamber, but the yield of trimetallic nitride metalloheterofullerenes is much lower with this experimental design of adding O2 or air to N2. During the burning (vaporization) production process, air is intentionally introduced into the chamber to assist with combustion and provide an oxidative environment within the reactor. In general the O₂ and NOₓ are combusted at temperatures ranging from about 500° C. to about 4000° C. This oxidizing environment of oxygen and NOₓ is key to making the trimetallic nitride metalloheterofullerenes. Without the NOₓ vapor, the formation of trimetallic nitride metalloheterofullerenes is difficult. The uniqueness of our invention is the serendipitous discovery of the use of oxidizing gases such as NOₓ to permit making new trimetallic nitride metalloheterofullerenes. Furthermore the formation of La₃N@C₇₉N, can only be created by this method of adding NOₓ. For example, La₃N@C₈₀ cannot be made with the U.S. Pat. No. 6,303,760 or U.S. patent application #20050232842 (Dunsch). Nor does using the procedure in U.S. Pat. No. 6,303,760 or U.S. patent application #20050232842 (Dunsch) make La₃N@C₈₀.

A potential is applied across the electrodes resulting in an arc discharge. The arc discharge consumes the graphite rod and generates a wide range of carbon products generally referred to as soot. Within the soot is a wide range of fullerenes including the trimetallic nitride endohedral metalloheterofullerenes.

Isolation of the trimetallic nitride endohedral metallofullerenes involves use of carbon disulfide or toluene to extract the soluble fullerenes from the soot. Isolation of trimetallic nitride endohedral metallofullerenes are done by chromatograpy (HPLC), see Stevenson et al, Nature, (1999) 401: 55-57, or by selective uptake to a solid support all non-trimetallic endohedral metallofullerenes. See Stevenson et al, Journal of the American Chemical Society, (2006), 128, 27, 8829-8835.

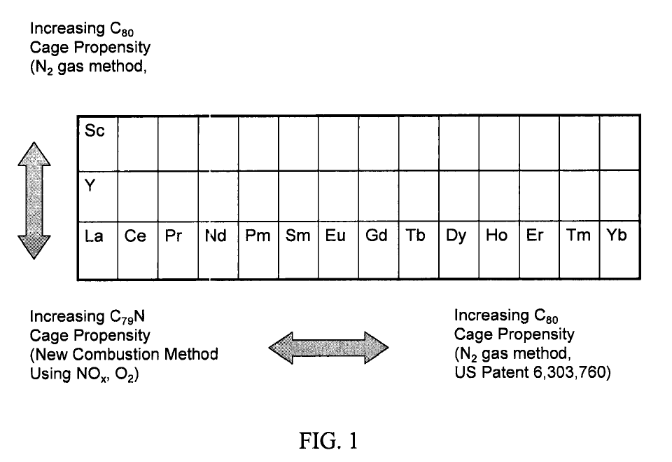

We have serendipitously discovered an inverse relationship between the propensity to form typical Cₙ cages (e.g., C₈₀) versus CₙN(C₇₉N) cages, as shown in FIG. 1. Namely, the metals in the metallic nitride clusters that are made in high yield in C₈₀ cages (e.g., SC₃N@C₈₀, Lu₃N@C₈₀) seem to have a decreased propensity to forming C₇₉N cages. Conversely, metals in metallic nitride clusters that have poor yields in C₈₀ cages seem to have an increased propensity to form C₇₉N cages. This inverse relationship or composition of matter is not obvious to any of us skilled in the art as noted by almost 10 years since the advent of trimetallic nitride C₈₀ metallofullerenes. Moreover, the primary advantage of trimetallic nitride metalloheterofullerenes is the orders of magnitude (10 to 100) increase in yield for the trimetallic nitride metalloheterofullerenes over the paucity of classical metallofullerenes. Namely, in the presence of NOₓ, the yield of most of the classical metallofullerenes is approximately nothing (e.g., on the order of detection limits).

Heterofullerenes are useful as superconductor materials, catalysts, and nonlinear optical materials. Heterofullerene compounds can also find utility as molecular carriers for drugs or catalysts. Heterofullerenes containing radioactive metals can be useful in missile therapy for cancer and as a radionuclide tracer. The gadolinium containing C₇₉N (e.g., GdSc₂N@C₇₉N, Gd₂ScN@C₇₉N, and Gd₃N@C₁₉N) are MRI active and provide pharmaceutical companies with alternative MRI contrast agents. Another commercial advantage which distinguishes our new molecules is the safety advantage of the encapsulated Gd atom(s) which can't escape from the cage. The advantage of having a dissimilar N atom within the carbon cage network permits selective functionalization at or near the N cage atom. In contrast, current Gd-containing MRI agents are chelates, instead, and hence the Gd can escape from the ligand and would then be a toxic, heavy metal in the body.

The present invention is illustrated in the following examples. The examples are provided for illustration purposes and should not be construed as limiting the scope of the present invention.

### EXAMPLES

### Experimental Details

Briefly, a metal-packed rod (anode) and a graphite rod (cathode) are placed inside a typical electric arc fullerene reactor. The reactor chamber is pumped down to remove air and backfilled with an inert gas (e.g., helium, He) to achieve a reduced pressure (typically 300 torr). Under dynamic flow of He gas, oxygen gas (O₂), is introduced in air at a range of flow rates (typically 0.05 torr/min to 20 torr/min). A pressure control valve permits us to maintain flow rates of He and other gases (e.g., O₂, NOₓ) and still maintain reduced pressures during the experiment. Other chemicals and reagents can be introduced into the packed rod (anode), which is a cored, graphite rod packed with the desired metal to encapsulate (e.g., transition metals such as Sc, Y, La and rare-earth metals such as Gd, Er, Ho, Th, Lu, Dy, Ce, Pr, Nd, etc.). NO, is a generic label for NO and NO₂, and also includes other gases such as N₂O, N₂O₅, N₂O₃, N₂O₄. Other solids can be added to the packing mixture. For example, catalyst additives (Cu metal) and/or reagents that decompose to release catalysts (e.g., Cu metal) and/or liberate oxidizing gases (e.g., oxygen gas, O₂, NOₓ, etc.) can also be mixed together (see e.g., Stevenson et al., “Chemically Adjusting Plasma Temperature, Energy and Reactivity (CAPTEAR) Method Using NOₓ and Combustion for Selective Synthesis of Sc₃N@C₈₀ Metallic Nitride Fullerenes,” J. Am. Chem. Soc., 129: 16257-15262 (December 2007) in the packing material along with the transition metals and/or rare-earth metals, which are part of the trimetallic nitride cluster.

### Example 1

### Synthesis of Homometal, Trimetallic Nitride Clusters in HeteroFullerene Cages (A₃N@CₙN)—Type I

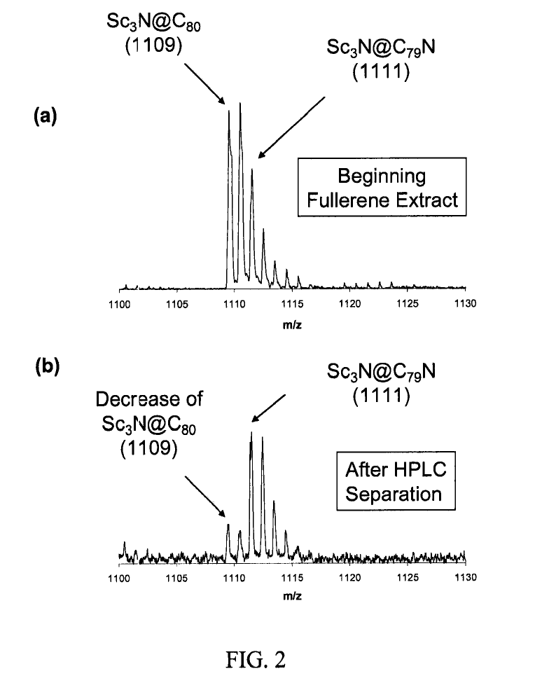

Upon vaporization of the packed rod using the electric-arc process under these oxidizing and combustive conditions, this new class of molecules are formed, along with other common types of empty-cage fullerenes (e.g., C₆₀, C₇₀, C₈₄, etc), classical metallofullerenes without nitrogen (e.g., M@Cₙ, M₂@Cₙ, M₃@Cₙ, M₄@Cₙ, etc), and predominantly amorphous carbon soot. Solvents such as xylene or carbon disulfide can be added to this asproduced dry soot for extraction of fullerene material. Upon subsequent (1) filtration to remove insolubles (e.g., amorphous carbon, nanotubes, etc.) and (2) solvent evaporation, a dried fullerene-containing extract is obtained. Analysis of fullerene extract by MALDI mass spectrometry reveals the presence of our new composition of matter. FIG. 2 shows that the SC₃N@C₇₉N species is present as a very minor component in the soot extract. However, after subsequent HPLC separation, the Sc₃N@C₈₀ species (m/z, 1109, FIG. 2a) can be sufficiently removed from the extract to permit the mass spectral signal for Sc₃N@C₇₉N (m/z, 1111, FIG. 2b) to be observed.

For other transition metals and some rare-earth metals, the detection of trimetallic nitride clusters in CₙN heteroatom cares is more readily observed directly from the soot extract. For example Y₃N(C₇₉N (1243), Lu₃N(C₇₉N (1501), Tb₃N@C₇₉N (1453) and Ho₃N@C₇₉N are readily distinguishable from their respective C₈₀ fullerene counterparts. Given the difference of only 2 mass units between M₃N@Cₙ versus M₃N@CₙN molecules, the detection and deconvolution of individual isotopic peaks can be difficult. For example, Er₃N@C₈₀ contains a broad range of isotope peaks from mass ranges of 1468 to 1487. A similar broad, distribution of isotope peaks for Er₃N@C₇₉N, 1470 to 1489 is also evident from mass spectral isotope peak analysis. Similarly, Gd₃N@C₇₉N and Dy₃N@C₇₉N also provide a broad range of isotope peaks.

### Example 2

### Synthesis of Mixed Trimetallic Nitride Clusters in HeteroFullerene Cages (AₓZ₃₋ₓ@CₙN)—Type II

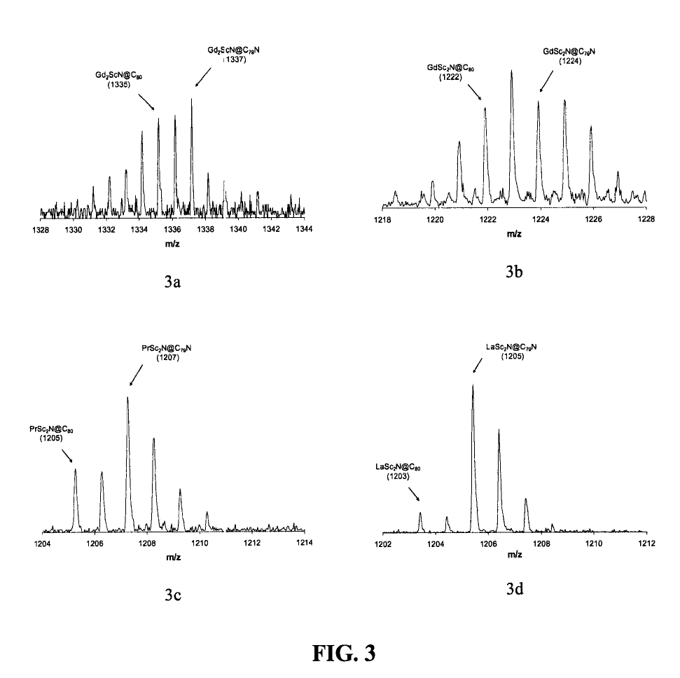

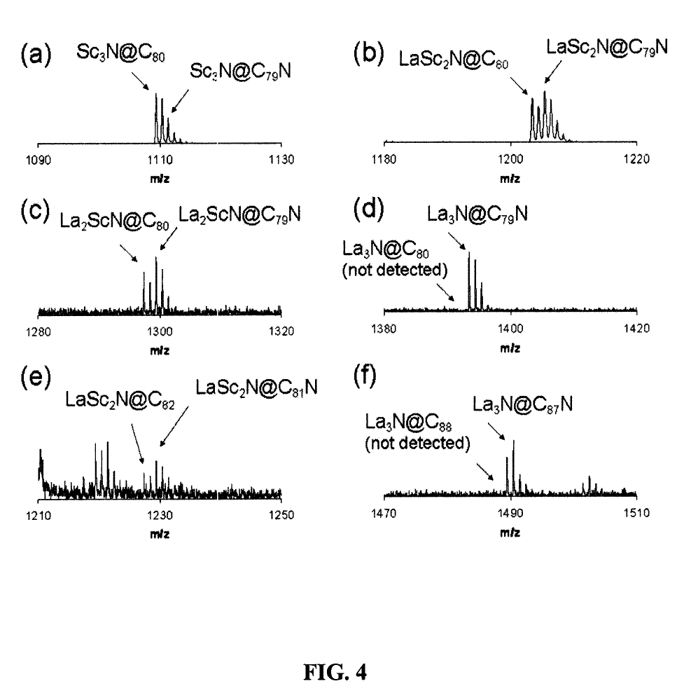

Alternatively, the trimetallic nitride cluster can contain a mixture of different metal types to form our new Type II molecule. Synthetically, this species is made by mixing the desired metals into the packing material (anode) prior to electric-arc vaporization. Mass spectral analysis of soot extracts prepared in such a manner is shown in FIG. 3. Representative examples include, but are not limited to, scandium metal atom(s) mixed with rare-earth metals such as Pr, La, and Gd. The formation of La₃N@C₇₉N, Sc₃N@C₇₉N, LaSc₂N@C₇₉N, and La₂ScN@C₇₉N are shown in FIG. 4. Also of note, a representative example with Gd/Sc mixtures shows that Gd₂ScN@C₇₉N and GdSc₂N@C₇₉N can both be made. These Gd/Sc molecules are especially of relevance as new candidate, MRI contrast agent pharmaceuticals.

### Comparative Example 3

### Comparison of Attempted Synthesis of Mixed Trimetallic Nitride Clusters in HeteroFullerene Cages (AₓZ₃₋ₓ@CₙN) using our Method Versus Other Methods

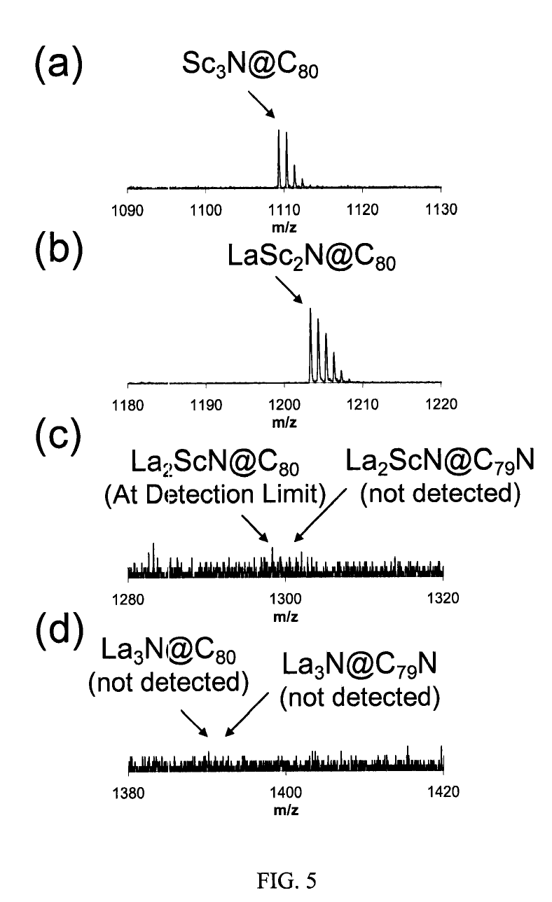

The Dorn methods of U.S. Pat. No. 6,303,760 and Dorn 20080279745 use a neutral form of nitrogen, i.e., N₂ gas as a source of nitrogen in an electric-arc reactor. Using the Dorn method, U.S. Pat. No. 6,303,760, one produces trimetallic nitride clusters in C₈₀ cages. Implementation of the Dorn method 20080279745 produces a trimetallic nitride cluster in a C₈₀ cage or a M₂@C₇₉N species, e.g., La₂@C₇₉N, Tb₂@C₇₉N, but not with both a trimetallic nitride cluster and a CₙN cage. It is only with our NOₓ and combustion method in our reactor that we can make both the trimetallic nitride cluster AND a C₇₉N heteroatom cage. Our experimental results using the Dorn methods, U.S. Pat. No. 6,303,760 and Dorn 20080279745 with N₂ demonstrate failure to produce our invention of trimetallic nitride metalloheterofullerenes. Our comparison data in FIG. 5a-d shows the fullerene type and product distribution of compounds made using these N₂-based Dorn methods. For comparison with the Dorn methods, FIG. 4 demonstrates our successful ability to produce trimetallic nitride metalloheterofullerenes using our NOₓ and O₂ method. Note that without NOₓ, (FIG. 5), it is not possible to place 3 bulky La atoms and a N inside a 80-atom cage, but with NOₓ, it is now possible to reduce to practice the synthesis of our new molecule with a composition of matter of La₃N@C₇₉N, (FIG. 4), a subset of our claimed family of molecules, A₃N@CₙN.

The Dunsch method (20050232842) uses a reduced form of nitrogen, e.g., NH₃, ammonia as a reactive gas in the electric-arc reactor to produce trimetallic nitride metallofullerenes. Using NH₃ as a source of nitrogen, the Dunsch method successfully puts a trimetallic nitride inside the C₈₀ fullerene cage, but yet mass spectral results fail to show trimetallic nitride clusters in C₇₉N fullerene cages to make trimetallic nitride metalloheterofullerenes, i.e., an inability to embed and substitute a N atom within the all-carbon fullerene cage PLUS add a N atom inside the cage, i.e., create a trimetallic nitride cluster.

It will therefore be readily understood by those persons skilled in the art that the present invention is susceptible to broad utility and application. Many embodiments and adaptations of the present invention other than those herein described, as well as many variations, modifications and equivalent arrangement, will be apparent from or reasonably suggested by the present invention and the foregoing description thereof, without departing from the substance or scope of the present invention.

Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims and the equivalents thereof.

What is claimed is:

1. An endohedral metalloheterofullerene having the formula: AₓX₃₋ₓN@CₙN, (x=0, 1, 2 or 3) (n=an odd integer between about 59 and about 199), wherein A and X are metal atoms.

2. The metalloheterofullerene of claim 1 wherein n is 77, 79, 81, 83, 85, 87, 89, 91, 93, 95, 97, 99, 101, 103, 105, 107, or 109.

3. The metalloheterofullerene of claim 1 wherein: A is selected from the group consisting of scandium, yttrium, lanthanum, neodymium, cerium, terbium, gadolinium, holmium, erbium, thulium, dysprosium, praseodymium and ytterbium; and X is selected from the group consisting of scandium, yttrium, lanthanum, neodymium, cerium, terbium, gadolinium, holmium, erbium, thulium, dysprosium, praseodymium and ytterbium.

4. The metalloheterofullerene of claim 1 wherein A or X is gadolinium.

5. The metalloheterofullerene of claim 1 wherein A or X is scandium.

6. The metalloheterofullerene of claim 1 wherein A or X is holmium.

7. The metalloheterofullerene of claim 1 wherein X and A are different.

8. The metalloheterofullerene of claim 1 wherein X and A are the same.

9. The metalloheterofullerene of claim 1 wherein A or X is selected from the group consisting of a rare earth element and group IIIB element.

10. The metalloheterofullerene of claim 1 having the formula: Sc₃N@C₇₉N, Y₃N@C₇₉N, La₃N@C₇₉N, Ce₃N@C₇₉N, Pr₃N@C₇₉N, Nd₃N@C₇₉N, Tb₃N@C₇₉N, Ho₃N@C₇₉N, Tm₃N@C₇₉N, Lu₃N@C₇₉N, Er₃N@C₇₉N, Gd₃N@C₇₉N or Dy₃N@C₇₉N, or mixed-metal species selected from the group consisting of LaSc₂N@C₇₉N, PrSc₂N@C₇₉N, GdSc₂N@C₇₉N, Gd₂ScN@C₇₉N

11. A method for making ail endohedral metalloheterofullerene comprising:
charging a reactor with a first metal, carbon, O₂ and NOₓ or compound that generates NOₓ; and
reacting the O₂ and NOₓ the first metal, and the carbon in the reactor to form an endohedral metalloheterofullerene of the formula AₓX₃₋ₓN@CₙN, (x=0, 1, 2 or 3) (n=an odd integer between about 59 and about 199), wherein A and X are metal atoms.

12. The method of claim 11 wherein the NOₓ is introduced in the reactor in the form of gas or compound that generates NOₓ; and the first metal and the carbon are introduced in the reactor in the form of a rod filled with a mixture of a first metal oxide and graphite wherein the first metal oxide is an oxide of the first metal.

13. The method of claim 11 wherein the first metal is selected from the group consisting of a rare earth element and a group IIIB element.

14. The method of claim 11 wherein the first metal is selected from the group consisting of scandium, yttrium, lanthanum, gadolinium, holmium, erbium, thulium, and ytterbium.

15. The method of claim 11 wherein the mixture comprises from about 0.1% to about 99.9% first metal oxide by weight.

16. The method of claim 11 wherein the mixture comprises about 0.1% to about 99.9% metal or metal oxide or other form of the metal.

17. The method of claim 11 wherein the O₂ and NOₓ are introduced at pressure rates each from ranges of about 0.05 torr/min to about 20 torr/min.

18. The method of claim 11 wherein the O₂ and NOₓ are combusted at temperatures ranging from about 500° C. to about 4000° C.

19. An endohedral metalloheterofullerene having the formula: AXZN@CₙN, (n=an odd integer between about 59 and about 199), wherein A, X, and Z are any combination of all dissimilar transition met al or rare-earth metal atoms.

20. The metalloheterofullerene of claim 19 having the formula GdScHoN@CₙN, or GdHoErN@CₙN.
